(19) United States
(12) Patent Application Publication
(10) Pub. No.: US 2024/0347911 A1
(43) Pub. Date: Oct. 17, 2024

(54) COMPACT MIMO BASE STATION ANTENNAS THAT GENERATE ANTENNA BEAMS HAVING NARROW AZIMUTH BEAMWIDTHS

(71) Applicant: CommScope Technologies LLC, Claremont, NC (US)

(72) Inventors: Xiangyang AI, Plano, TX (US); Chengcheng TANG, Murphy, TX (US); HongHui CHEN, Suzhou (CN); Jing XU, Suzhou (CN)

(21) Appl. No.: 18/579,783

(22) PCT Filed: Jul. 12, 2022
(86) PCT No.: PCT/US22/36753

§ 371 Date: Jan. 16, 2024

Related U.S. Application Data
(60) Provisional application No. 63/224,999, filed on Jul. 23, 2021.

(51) Int. Cl. H01Q 5/42; H01Q 1/24; H01Q 5/48; H01Q 19/10; H01Q 21/06

(52) U.S. Cl. CPC H01Q 5/42; H01Q 1/246; H01Q 5/48; H01Q 21/062; H01Q 19/104

(57) ABSTRACT

Base station antennas include a first RF port having a plurality of first radiating elements coupled thereto that form a first array and a second RF port having a plurality of second radiating elements coupled thereto that form a second array. At least some of the first radiating elements are arranged as a plurality of vertically-stacked triangular arrangements of first radiating elements and at least some of the second radiating elements are arranged as a plurality of vertically-stacked triangular arrangements of second radiating elements. One of the first radiating elements i a first of the triangular arrangements of first radiating elements is positioned in between two of the second radiating elements in a first of the triangular arrangements of second radiating elements.

### CROSS-REFERENCE TO RELATED APPLICATION

The present application claims priority to U.S. Provisional Application Ser. No. 63/224,999, filed Jul. 23, 2021, the entire content of which is incorporated herein by reference.

### FIELD

The present invention generally relates to radio communications and, more particularly, to base station antennas utilized in cellular and other communications systems.

### BACKGROUND

Cellular communications systems are well known in the art. In a typical cellular communications system, a geographic area is divided into a series of regions that are referred to as “cells,” and each cell is served by a base station. The base station may include baseband equipment, radios and base station antennas that are configured to provide two-way radio frequency (“RF”) communications with subscribers that are positioned throughout the cell. In many cases, the cell may be divided into a plurality of “sectors,” and separate base station antennas provide coverage to each of the sectors. The base station antennas are often mounted on a tower or other raised structure, with the radiation beam (“antenna beam”) that is generated by each antenna directed outwardly to serve a respective sector. Typically, a base station antenna includes one or more phase-controlled arrays of radiating elements, with the radiating elements arranged in one or more vertical columns when the antenna is mounted for use. Herein, “vertical” refers to a direction that is generally perpendicular relative to the plane defined by the horizon. References will also be made herein to the “azimuth” and “elevation” planes. The azimuth plane refers to a horizontal plane that bisects the base station antenna that is parallel to the plane defined by the horizon. The elevation plane refers to a plane that is perpendicular to the azimuth plane that bisects the front surface of the base station antenna.

A common base station configuration is a “three sector” configuration in which a cell is divided into three 120° sectors in the azimuth plane, and the base station includes three base station antennas that provide coverage to the three respective sectors. In a three sector configuration, the antenna beams generated by each base station antenna typically have a Half Power Beam Width (“HPBW”) in the azimuth plane of about 65°, as such an antenna beam may provide good coverage throughout a 120° sector without having significant RF energy spill over into the other two sectors. A HPBW of an antenna beam in the azimuth plane may be referred to as the “azimuth HPBW,” and a HPBW of an antenna beam in the elevation plane may be referred to as the “elevation HPBW.” Unless noted otherwise, references to the “azimuth HPBW” of an antenna beam refer to the azimuth HPBW at the center frequency of the operating frequency band of the array of radiating elements that form the antenna beam.

Each individual radiating element in the above-discussed arrays will typically be designed to generate an individual antenna beam (i.e., the antenna beam that is generated if an RF signal is only transmitted through a single radiating element of the array, which is also referred to herein as an “element pattern”) having a HPBW of about 65° in both the azimuth and elevation planes. The azimuth HPBW of an antenna beam generated by an array that includes multiple radiating elements is a function of (among other things) the azimuth HPBW of the element pattern of the radiating elements (note that typically the radiating elements in an array are identical and hence all have the same element pattern) and the distance between the leftmost and rightmost radiating elements in the array (referred to as the “aperture” of the array in the azimuth plane). As noted above, for a three-sector base station, it is typically desired that the antenna beams generated by an array of radiating elements have an azimuth HPBW of about 65°. Since most radiating elements are designed to have an azimuth HPBW of about 65°, a single radiating element, or a vertically-extending column of radiating elements, will generate antenna beams having the desired 65° azimuth HPBW.

The elevation HPBW of an antenna beam generated by an array of radiating elements is a function of the elevation HPBW of the element pattern of the radiating elements and the distance between the topmost and bottommost radiating elements in the array (i.e., the aperture of the array in the elevation plane). In most applications, cellular operators desire antenna beams having an elevation HPBW that is much smaller than 65°, such as elevation HPBWs of 10°-30°. To narrow the beamwidth in the elevation plane, a column of radiating elements are used so that the aperture of the array in the elevation plane is increased. Such columns of radiating elements are often referred to as “linear arrays.” An RF signal that is to be transmitted by such a linear array is split into a plurality of sub-components that are fed to the respective individual radiating elements in the linear array. The vertical spacing between the radiating elements in the linear array is typically kept below about 0.9*λ, where λ is the wavelength corresponding to the center frequency of the operating frequency band in order to suppress grating lobe formation (which are undesired sidelobes having peak radiation outside of the azimuth and elevation planes). The more radiating elements that are added to the column (thereby increasing the distance between the topmost and bottommost radiating elements) the narrower the resulting elevation HPBW. Each linear array generates an antenna beam or, if the linear array is formed using dual-polarized radiating elements, forms an antenna beam at each of two orthogonal polarizations.

Various applications exist where cellular operators require base station antennas that form antenna beams having azimuth HPBWs that are less than 65°. For example, to increase capacity, some base stations are configured in a so-called “six sector” configuration in which the cell is divided into six 60° sectors in the azimuth plane, and the base station includes six base station antennas that generate antenna beams having azimuth HPBWs of about 33° so that each antenna beam provides good coverage to a 60° sector in the azimuth plane. Base station antennas that generate antenna beams having azimuth HPBWs of about 33° are also used to provide cellular service along tunnels, bridges, railroad tracks, highways and the like, since an antenna beam having a narrow azimuth HPBW can provide high gain and good coverage to long, relatively straight coverage areas. Herein, base station antennas that form static antenna beams that have azimuth HPBWs (at the middle of the operating frequency band) of less than 45° are referred to as “narrow-beam” base station antennas.

In order to generate antenna beams having narrower azimuth HPBWs, two-dimensional arrays are used that include multiple columns of radiating elements, since using multiple columns increases the aperture in the azimuth plane. All of the radiating elements in the two-dimensional array are coupled to a common RF port (or to two RF ports when dual-polarized radiating elements are used). To generate antenna beams having an azimuth HPBW of about 33°, an array will typically include three columns of radiating elements that have element patterns with azimuth HPBWs of about 65°, where the columns are spaced apart from each other by about one half of a wavelength corresponding to the center frequency of the operating frequency band of the radiating elements/array.

In some applications, cellular operators desire base station antennas that generate antenna beams having narrow azimuth HPBWs and that also support multi-input-multi-output (“MIMO”) communications. MIMO refers to a technique where a baseband data stream is sub-divided into multiple sub-streams that are used to generate multiple RF signals that are transmitted through multiple different arrays of radiating elements. The arrays are, for example, spatially separated from one another and/or at orthogonal polarizations so that the transmitted RF signals will be sufficiently decorrelated. The multiple RF signals are recovered at the receiver and demodulated and decoded to recover the original data sub-streams, which are then recombined. The use of MIMO transmission techniques may help overcome the negative effects of multipath fading, and may be particularly effective in urban environments where reflections may increase the level of decorrelation between the RF signals. Typically, cellular operators desire antennas that support at least 4×MIMO communications, meaning that the base station antenna must generate four decorrelated antenna beams.

FIG. 1 is a schematic front view of a conventional narrow-beam base station antenna 1 that generates antenna beams having azimuth HPBWs of about 33° that support 4×MIMO communications. As shown in FIG. 1, the base station antenna 1 includes first and second multi-column arrays 20-1, 20-2 of radiating elements 24. The radiating elements 24 are mounted to extend forwardly from a reflector 10. The first array 20-1 includes three columns 22-1 through 22-3 of radiating elements 24, and the second array 20-2 includes three columns 22-4 through 22-6 of radiating elements 24. For ease of understanding, in the accompanying figures the radiating elements that are part of a first array of an antenna are enclosed within one or more dashed-line boxes and the radiating elements that are part of a second array of the antenna are enclosed within one or more dotted-line boxes so that each individual radiating element need not be separately numbered. The center-to-center distance between radiating elements 24 in adjacent columns 22 may be about a half of a wavelength corresponding to the center frequency of the operating frequency band of the radiating elements 24. Each radiating element 24 is implemented as a dual-polarized radiating element so that each array 20-1, 20-2 will generate two antenna beams, namely one at each polarization.

The base station antenna 1 further includes four RF ports 30-1 through 30-4. Each RF port 30 may have a connector interface that allows the RF port 30 to connect to a port of an external radio (e.g., via a coaxial cable). The first and third RF ports 30-1, 30-3 are connected to the radiating elements 24 of the first array 20-1, and the second and fourth RF ports 30-2, 30-4 are connected to the radiating elements 24 of the second array 20-2 via feed networks that are not shown in FIG. 1. RF signals input at the first RF port 30-1 are passed to first polarization radiators of the radiating elements 24 of the first array 20-1 to generate a first antenna beam, and RF signals input at the third RF port 30-3 are passed to second polarization radiators of the radiating elements 24 of the first array 20-1 to generate a second antenna beam. Similarly, RF signals input at the second RF port 30-2 are passed to first polarization radiators of the radiating elements 24 of the second array 20-2 to generate a third antenna beam, and RF signals input at the fourth RF port 30-4 are passed to second polarization radiators of the radiating elements 24 of the second array 20-2 to generate a fourth antenna beam.

While the conventional antenna 1 may perform well, mounting six columns 22 of radiating elements 24 on the reflector 10 results in a very wide antenna (e.g., a width of about 1200 mm). The increased antenna width may be unsightly and/or out of compliance with local zoning ordinances. Additionally, the large width may substantially increase the wind loading experienced by the antenna 1 as compared to narrower base station antennas, potentially increasing the structural requirements for the antenna, the mounting hardware, and/or the antenna tower. This can significantly increase the total costs associated with the base station antenna 1.

### SUMMARY

Pursuant to embodiments of the present invention, base station antennas are provided that include a reflector, a first RF port having a plurality of first radiating elements coupled thereto that form a first array, and a second RF port having a plurality of second radiating elements coupled thereto that form a second array. Each of the first and second radiating elements extend forwardly from the reflector. At least some of the first radiating elements are arranged as a plurality of vertically-stacked triangular arrangements of first radiating elements, and at least some of the second radiating elements are arranged as a plurality of vertically-stacked triangular arrangements of second radiating elements. One of the first radiating elements in a first of the triangular arrangements of first radiating elements is positioned between two of the second radiating elements in a first of the triangular arrangements of second radiating elements. In some embodiments, one of the second radiating elements in the first of the triangular arrangements of second radiating elements is positioned between two of the first radiating elements in the first of the triangular arrangements of first radiating elements. In some embodiments, one of the second radiating elements in the first of the triangular arrangements of second radiating elements is positioned directly above the one of the first radiating elements in the first of the triangular arrangements of first radiating elements, and/or

one of the first radiating elements in the first of the triangular arrangements of first radiating elements is positioned directly above the one of the second radiating elements in the first of the triangular arrangements of second radiating elements. In some embodiments, the one of the first radiating elements in the first of the triangular arrangements of first radiating elements and the two of the second radiating elements in the first of the triangular arrangements of second radiating elements are all horizontally aligned with each other.

In some embodiments, the first and second radiating elements are arranged side-by-side in first through fourth vertically-extending columns that are positioned in numerical order so that the first and fourth columns are outer columns and the second and third columns are inner columns. The first radiating elements that form the vertically-stacked triangular arrangements of first radiating elements may be located exclusively in the first through third vertically-extending columns, and the second radiating elements that form the vertically-stacked triangular arrangements of second radiating elements may be located exclusively in the second through fourth vertically-extending columns.

In some embodiments, a sum of a number of first radiating elements and a number of second radiating elements in the first column may be less than a sum of a number of first radiating elements and a number of second radiating elements in the second column. In other embodiments, a total number of first and second radiating elements in the second and third columns may be at least three times a total number of first and second radiating elements in either the first column or the fourth column.

In some embodiments, the first array may be configured to generate an antenna beam having a half power beamwidth in the azimuth plane of less than 40° in response to a first RF signal input at the first RF port, and the second array may be configured to generate an antenna beam having a half power beamwidth in the azimuth plane of less than 40° in response to a second RF signal input at the second RF port.

In some embodiments, one or more of the first radiating elements may be extra first radiating elements that are not part of the plurality of vertically-stacked triangular arrangements of first radiating elements, and one or more of the second radiating elements may be extra second radiating elements that are not part of the plurality of vertically-stacked triangular arrangements of second radiating elements. In these embodiments, the first through fourth vertically-extending columns may define a plurality of rows of first and second radiating elements, and the extra first radiating elements and the extra second radiating elements may all be located in rows that are no more than two rows from a center of the plurality of rows. In other embodiments, the first through fourth vertically-extending columns may define a plurality of rows, and the extra first radiating elements and the extra second radiating elements may all be located in the top two rows and/or the bottom two rows of the plurality of rows. In some embodiments, a total number of extra first radiating elements may be either one or two, and a total number of extra second radiating elements may be either one or two. In some embodiments, a number of first radiating elements in the first array may be equal to a number of second radiating elements in the second array.

Pursuant to further embodiments, base station antennas are provided that include a first RF port having a plurality of first radiating elements coupled thereto that form a first array that is configured to generate an antenna beam having an azimuth HPBW of less than 40° and a second RF port having a plurality of second radiating elements coupled thereto that form a second array that is configured to generate an antenna beam having an azimuth HPBW of less than 40° in response to a second RF signal. The first and second radiating elements are arranged in first through fourth vertically-extending columns that are positioned in numerical order, and the second and third columns each include respective total numbers of first and second radiating elements that exceeds respective total numbers of first and second radiating elements in either the first column or the fourth column.

In some embodiments, the first through fourth vertically-extending columns may define a plurality of rows, and all of the rows may include a first radiating element that is located in the second column or the third column and a second radiating element that is located in the other of the second column or the third column.

In some embodiments, at least some of the first radiating elements may be arranged as a plurality of vertically-stacked triangular arrangements of first radiating elements and at least some of the second radiating elements may be arranged as a plurality of vertically-stacked triangular arrangements of second radiating elements.

In some embodiments, some of the first radiating elements in the triangular arrangements of first radiating elements may be positioned in between some of the second radiating elements in the triangular arrangements of second radiating elements.

In some embodiments, one of the first radiating elements in a first of the triangular arrangements of first radiating elements may be positioned in between two of the second radiating elements in a first of the triangular arrangements of second radiating elements, and one of the second radiating elements in the first of the triangular arrangements of second radiating elements may be positioned in between two of the first radiating elements in the first of the triangular arrangements of first radiating elements.

In some embodiments, one of the second radiating elements in the first of the triangular arrangements of second radiating elements may be positioned directly above the one of the first radiating elements in the first of the triangular arrangements of first radiating elements, and/or

one of the first radiating elements in the first of the triangular arrangements of first radiating elements may be positioned directly above the one of the second radiating elements in the first of the triangular arrangements of second radiating elements. In some embodiments, the one of the first radiating elements in the first of the triangular arrangements of first radiating elements and the two of the second radiating elements in the first of the triangular arrangements of second radiating elements may all be horizontally aligned with each other.

In some embodiments, the first radiating elements that form the vertically-stacked triangular arrangements of first radiating elements may be located exclusively in the first through third vertically-extending columns, and the second radiating elements that form the vertically-stacked triangular arrangements of second radiating elements may be located exclusively in the second through fourth vertically-extending columns.

In some embodiments, one or more of the first radiating elements may be extra first radiating elements that are not part of the plurality of vertically-stacked triangular arrangements of first radiating elements, and one or more of the second radiating elements may be extra second radiating elements that are not part of the plurality of vertically-stacked triangular arrangements of second radiating elements.

In some embodiments, a total number of extra first radiating elements is either one or two, and a total number of extra second radiating elements may be either one or two.

Pursuant to still further embodiments of the present invention, base station antennas are provided that include a reflector, first and second RF ports, a first array that includes a plurality of first radiating elements that are coupled to the first RF port and mounted to extend forwardly from the reflector, where at least some of the first radiating elements are arranged as a plurality of vertically-stacked triangular arrangements of first radiating elements, and a second array that includes a plurality of second radiating elements that are coupled to the second RF port and that are mounted to extend forwardly from the reflector, where at least some of the second radiating elements are arranged as a plurality of vertically-stacked triangular arrangements of second radiating elements. At least some of the triangular arrangements of first radiating elements are interleaved with some of the triangular arrangements of second radiating elements.

In some embodiments, each of the triangular arrangements of first radiating elements may include two horizontally-aligned first radiating elements and an additional first radiating element that is vertically offset from the two horizontally-aligned first radiating elements and in between a pair of vertically-extending axes that bisect the two horizontally-aligned first radiating elements.

In some embodiments, each of the triangular arrangements of second radiating elements may include two horizontally-aligned second radiating elements and an additional second radiating element that is vertically offset from the two horizontally-aligned second radiating elements and in between a pair of vertically-extending axes that bisect the two horizontally-aligned second radiating elements.

In some embodiments, the first and second radiating elements may be arranged in first through fourth vertically-extending columns that are positioned in numerical order. The first radiating elements that form the vertically stacked triangular arrangements of first radiating elements may be located exclusively in the first through third vertically-extending columns, and the second radiating elements that form the vertically stacked triangular arrangements of second radiating elements may be located exclusively in the second through fourth vertically-extending columns. A sum of a number of first radiating elements and a number of second radiating elements in the first column may be less than a sum of a number of first radiating elements and a number of second radiating elements in the second column.

In some embodiments, the first array may be configured to generate an antenna beam having an azimuth HPBW of less than 40° in response to a first RF signal input at the first RF port, and the second array is configured to generate an antenna beam having an azimuth HPBW of less than 40° in response to a second RF signal input at the second RF port.

In some embodiments, one or more of the first radiating elements may be extra first radiating elements that are not part of the plurality of vertically stacked triangular arrangements of first radiating elements, and one or more of the second radiating elements may be extra second radiating elements that are not part of the plurality of vertically stacked triangular arrangements of second radiating elements.

In some embodiments, a total number of extra first radiating elements may be either one or two, and a total number of extra second radiating elements may be either one or two.

In some embodiments, at least 80% of the first radiating elements may be arranged as a plurality of vertically stacked triangular arrangements of first radiating elements, and at least 80% of the second radiating elements may be arranged as a plurality of vertically stacked triangular arrangements of second radiating elements.

Pursuant to further embodiments of the present invention, base station antennas are provided that comprise a reflector, a first RF port having a plurality of first radiating elements coupled thereto that form a first array, each of the first radiating elements extending forwardly from the reflector, and a second RF port having a plurality of second radiating elements coupled thereto that form a second array, each of the second radiating elements extending forwardly from the reflector. First through fourth of the second radiating elements are positioned directly above, directly below, directly to the left of and directly to the right of, respectively, one of the first radiating elements.

In some embodiments, first through fourth of the first radiating elements are positioned directly above, directly below, directly to the left of and directly to the right of, respectively, one of the second radiating elements.

In some embodiments, at least some of the first radiating elements are arranged as a plurality of vertically-stacked triangular arrangements of first radiating elements, and at least some of the second radiating elements are arranged as a plurality of vertically-stacked triangular arrangements of second radiating elements.

Pursuant to further embodiments of the present invention, base station antennas are provided that include a reflector, a first RF port having a plurality of first radiating elements coupled thereto that form a first array, each of the first radiating elements extending forwardly from the reflector, a second RF port having a plurality of second radiating elements coupled thereto that form a second array, each of the second radiating elements extending forwardly from the reflector. The first and second radiating elements are arranged in first through fourth vertically-extending columns that are positioned in numerical order, and the first and second radiating elements in the second and third vertically-extending columns are arranged as a plurality of vertically-stacked rectangular arrangements of first and second radiating elements. The first vertically-extending column includes a plurality of first radiating elements that are vertically offset with respect to all of the first and second radiating elements in the second and third vertically-extending columns.

In some embodiments, the fourth vertically-extending column includes a plurality of second radiating elements that are vertically offset with respect to all of the first and second radiating elements in the second and third vertically-extending columns.

In some embodiments, each first radiating element in the first vertically-extending column is horizontally aligned with a respective second radiating element in the fourth vertically-extending column to form a plurality of horizontally aligned pairs of radiating elements.

In some embodiments, respective horizontal lines that bisect each horizontally aligned pair of radiating elements extend through a central region of a respective one of the vertically-stacked rectangular arrangements of first and second radiating elements.

In some embodiments, a sum of a number of first radiating elements and a number of second radiating elements in the second column is at least 50% more than a sum of a number of first radiating elements and a number of second radiating elements in the first column.

In some embodiments, the first array is configured to generate an antenna beam having a half power beamwidth in the azimuth plane of less than 40° in response to a first RF signal input at the first RF port, and the second array is configured to generate an antenna beam having a half power beamwidth in the azimuth plane of less than 40° in response to a second RF signal input at the second RF port.

Pursuant to still further embodiments of the present invention, base station antennas are provided that first and second RF ports and a plurality of radiating elements that are arranged in first through fourth vertically-extending columns, the vertically-extending columns positioned in numerical order and the radiating elements aligned in X horizontally-extending rows that are positioned in numerical order, the plurality of radiating elements arranged as a first array and a second array. The first array comprises all of the radiating elements in the first X-Y rows of the first and second vertically extending columns and all of the radiating elements in the last Y rows of the third and fourth vertically-extending columns. The second array comprises all of the radiating elements in the first X-Y rows of the third and fourth vertically extending columns and all of the radiating elements in the last Y rows of the first and second vertically-extending columns.

### BRIEF DESCRIPTION OF THE DRAWINGS

FIG. 1 is a schematic front view of a conventional narrow-beam base station antenna that supports 4×MIMO communications.

FIG. 2 is a schematic front view of a narrow-beam base station antenna according to embodiments of the present invention that has multi-column L-shaped arrays.

FIG. 3A is a schematic front view of a base station antenna according to embodiments of the present invention that has two interleaved arrays of radiating elements where each array comprises vertically-stacked triangular arrangements of radiating elements.

FIG. 3B is a schematic front view of the base station antenna of FIG. 3A that further illustrates one of the four feed networks included in the antenna.

FIG. 3C is an enlarged view of a portion of the base station antenna of FIG. 3A.

FIG. 3D is a schematic front view of a base station antenna according to further embodiments of the present invention that has two interleaved arrays of radiating elements where unused radiating elements are omitted for cost reduction purposes.

FIG. 4 is a schematic front view of a base station antenna according to embodiments of the present invention that has two interleaved arrays of radiating elements where each array comprises vertically-stacked triangular arrangements of radiating elements and where each array includes an additional radiating element that is added in a middle portion of the array.

FIG. 5 is a schematic front view of a base station antenna according to embodiments of the present invention that has two interleaved arrays of radiating elements where each array comprises vertically-stacked triangular arrangements of radiating elements and where each array includes an additional radiating element that is added at the top of the array.

FIG. 6 is a schematic front view of a base station antenna according to embodiments of the present invention that has two interleaved arrays of radiating elements where each array comprises vertically-stacked triangular arrangements of radiating elements and where each array includes two additional radiating elements that are added in a middle portion of the array.

FIG. 7 is a schematic front view of a base station antenna according to embodiments of the present invention that has two interleaved arrays of radiating elements where each array comprises vertically-stacked triangular arrangements of radiating elements and where each array includes an additional radiating element that is added in a middle portion of the array.

FIG. 8 is a schematic front view of a base station antenna according to embodiments of the present invention that has two interleaved arrays of radiating elements where each array comprises vertically-stacked triangular arrangements of radiating elements and where each array includes two additional radiating elements that are added at the top and bottom of the array.

FIG. 9 is a schematic front view of a base station antenna according to embodiments of the present invention that has two arrays of radiating elements that are interleaved in a checkerboard arrangement.

FIG. 10 is a schematic front view of a multiband base station antenna according to embodiments of the present invention.

FIG. 11 is a schematic front view of a base station antenna according to further embodiments of the present invention that includes vertically-staggered columns of radiating elements.

FIG. 12A is a schematic front view of a base station antenna according to further embodiments of the present invention that illustrates an alternative approach to vertically-staggering the columns of radiating elements.

FIG. 12B is an enlarged view of a portion of the base station antenna of FIG. 12A.

Note that the radomes of the base station antennas are not shown in the above-described figures so that the arrangements of radiating elements are visible in the drawings. It will be appreciated that the base station antennas according to embodiments of the present invention will typically include a radome that protects the internal components of the antenna.

Herein, when multiple of the same elements are included in an antenna, the elements may be referred to individually by their full reference numeral (e.g., column 120-2) and collectively by the first part of their reference numerals (e.g., the columns 120).

### DETAILED DESCRIPTION

Pursuant to embodiments of the present invention, narrow-beam base station antennas are provided that support 4×MIMO communications. In some embodiments, these narrow-beam base station antennas may generate antenna beams having azimuth HPBWs of about 33° (or less) so that they may be suitable for use in six-sector base stations. In other embodiments, the base station antennas have slightly larger azimuth HPBWs, such as azimuth HPBWs in the 35°-45° range.

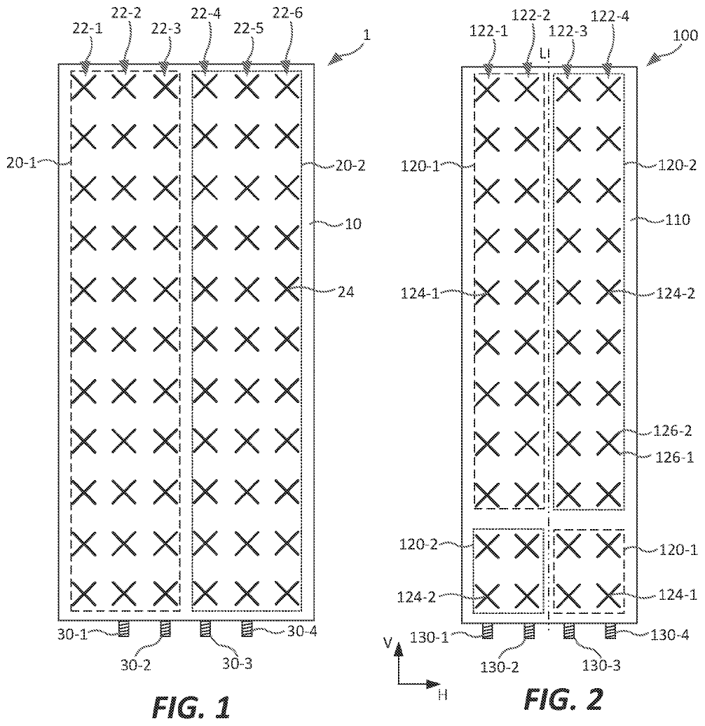

The base station antennas according to embodiments of the present invention may include two interleaved arrays of dual-polarized radiating elements. Due to the interleaving of the radiating elements of the two arrays, both arrays may be implemented using a total of four columns of radiating elements as opposed to the six columns of radiating elements included in the conventional narrow-beam base station antenna discussed above with reference to FIG. 1.

The base station antennas according to embodiments of the present invention may have two arrays of radiating elements that each comprise vertically-stacked triangular arrangements of radiating elements. In some embodiments, each array may further include a few additional or “extra” radiating elements that may be provided to help achieve desired HPBWs in the azimuth and/or elevation planes. The vertically-stacked triangular arrangements of radiating elements may be implemented by only feeding some of the radiating elements in a conventional four-column array. In some embodiments, the unused radiating elements of the four-column array may be omitted in order to reduce the cost and weight of the antenna. The first and second arrays may each be configured to generate antenna beams having an azimuth HPBW of less than 40°.

In some example embodiments, base station antennas are provided that include a first RF port having a plurality of first radiating elements coupled thereto that form a first array and a second RF port having a plurality of second radiating elements coupled thereto that form a second array. At least some of the first radiating elements are arranged as a plurality of vertically-stacked triangular arrangements of first radiating elements and at least some of the second radiating elements are arranged as a plurality of vertically-stacked triangular arrangements of second radiating elements. One of the first radiating elements in a first of the triangular arrangements of first radiating elements is positioned directly in between two of the second radiating elements in a first of the triangular arrangements of second radiating elements. Similarly, one of the second radiating elements in a first of the triangular arrangements of second radiating elements is positioned directly in between two of the first radiating elements in the first of the triangular arrangements of first radiating elements. Each triangular arrangements of first or second radiating elements may include two horizontally-aligned radiating elements and a third radiating element that is vertically offset from the two horizontally-aligned radiating elements and in between a pair of vertically-extending axes that bisect the two horizontally-aligned radiating elements. A radiating element of a different triangular arrangements of first or second radiating elements may be positioned between the two horizontally-aligned radiating elements of each triangular arrangement of first or second radiating elements.

The first and second radiating elements may be arranged in first through fourth vertically-extending columns that are positioned in numerical order. The first radiating elements that form the vertically-stacked triangular arrangements of first radiating elements may be located exclusively in the first through third vertically-extending columns, and the second radiating elements that form the vertically-stacked triangular arrangements of second radiating elements may be located exclusively in the second through fourth vertically-extending columns. The total number of first and second radiating elements in the first column may be less than the total number of first and second radiating elements in the second column.

The first array may include one or more “extra” first radiating elements that are not part of the plurality of vertically-stacked triangular arrangements of first radiating elements, and the second array may include one or more “extra” second radiating elements that are not part of the plurality of vertically-stacked triangular arrangements of second radiating elements.

In other example embodiments, base station antennas are provided that include a first RF port having a plurality of first radiating elements coupled thereto that form a first array and a second RF port having a plurality of second radiating elements coupled thereto that form a second array. At least some of the first radiating elements are arranged as a plurality of vertically-stacked triangular arrangements of first radiating elements and at least some of the second radiating elements are arranged as a plurality of vertically-stacked triangular arrangements of second radiating elements. The first and second arrays may each be configured to generate antenna beams having an azimuth HPBW of less than 40°. The first and second radiating elements are arranged in first through fourth vertically-extending columns that are positioned in numerical order, and the second and third columns each include a respective total number of first and second radiating elements that exceeds respective total numbers of first and second radiating elements in either the first column or the fourth column.

In still further example embodiments, base station antennas are provided that include a reflector, first and second RF ports, and first and second arrays. The first array includes a plurality of first radiating elements that are coupled to the first RF port and mounted to extend forwardly from the reflector, and the second array includes a plurality of second radiating elements that are coupled to the second RF port and that are mounted to extend forwardly from the reflector. At least some of the first radiating elements are arranged as a plurality of vertically-stacked triangular arrangements of first radiating elements, and at least some of the second radiating elements are arranged as a plurality of vertically-stacked triangular arrangements of second radiating elements. At least some of the triangular arrangements of first radiating elements are interleaved with some of the triangular arrangements of second radiating elements.

In some embodiments, at least 80% of the first radiating elements are arranged as a plurality of vertically-stacked triangular arrangements of first radiating elements, and at least 80% of the second radiating elements are arranged as a plurality of vertically-stacked triangular arrangements of second radiating elements.

In other example embodiments, base station antennas are provided that include a reflector, first and second RF ports, and first and second arrays. The first array includes a plurality of first radiating elements that are coupled to the first RF port and mounted to extend forwardly from the reflector, and the second array includes a plurality of second radiating elements that are coupled to the second RF port and that are mounted to extend forwardly from the reflector. First through fourth of the second radiating elements are positioned directly above, directly below, directly to the left of and directly to the right of, respectively, one of the first radiating elements. Additionally, first through fourth of the first radiating elements may be positioned directly above, directly below, directly to the left of and directly to the right of, respectively, one of the second radiating elements.

Embodiments of the present invention will now be discussed in more detail with reference to FIGS. 2-11.

FIG. 2 is a schematic front view of a narrow-beam base station antenna 100 according to embodiments of the present invention that generates antenna beams having azimuth HPBWs of, for example, less than 40° (e.g., about 33°). The base station antenna 100 may support 4×MIMO communications. As shown in FIG. 2, the base station antenna 100 includes four columns 122-1 through 122-4 of radiating elements 124. The radiating elements 124 are mounted to extend forwardly from a reflector 110. The reflector 110 may, in example embodiments, comprise a sheet of metal that serves as a ground plane for the radiating elements 124 and that also redirects forwardly much of the backwardly-directed radiation emitted by the radiating elements 124. The radiating elements 124 may comprise first radiating elements 124-1 that form a first array 120-1 of radiating elements 124-1 and second radiating elements 124-2 that form a second array 120-2 of radiating elements 124-2.

The radiating elements 124 may be mid-band radiating elements that are configured to operate in some or all of the 1427-2690 MHz frequency band. Each radiating element 124 may comprise, for example, a −45°/+45° cross-dipole radiating element that has a first dipole radiator 126-1 that extends at an angle of 45° with respect to the longitudinal axis of the antenna 100 and a second dipole radiator 126-2 that extends at an angle of +45° with respect to the longitudinal axis of the antenna 100. Thus, the radiating elements 124 are schematically illustrated in FIG. 2 (and the other figures herein) using X's, where each line of the X represents a dipole radiator 126-1, 126-2. Each column 122 may extend along an axis that is parallel to a longitudinal axis L of the base station antenna 100. The columns 122 may be spaced apart from each other in the horizontal direction H.

Base station antennas are typically mounted so that the longitudinal axis L of the antenna extends vertically with respect to a horizontal plane defined by the horizon. Accordingly, the longitudinal axis L is shown as being parallel to the vertical direction V in FIG. 2 (and the other figures). It will be appreciated, however, that in many situations base station antennas may be mechanically down-titled a small amount from a vertical orientation, such as a downtilt angle of up to 15°. A column of radiating elements that extends parallel to the longitudinal axis L is considered to be a vertically-extending column even if the base station antenna is mechanically downtilted when mounted for use.

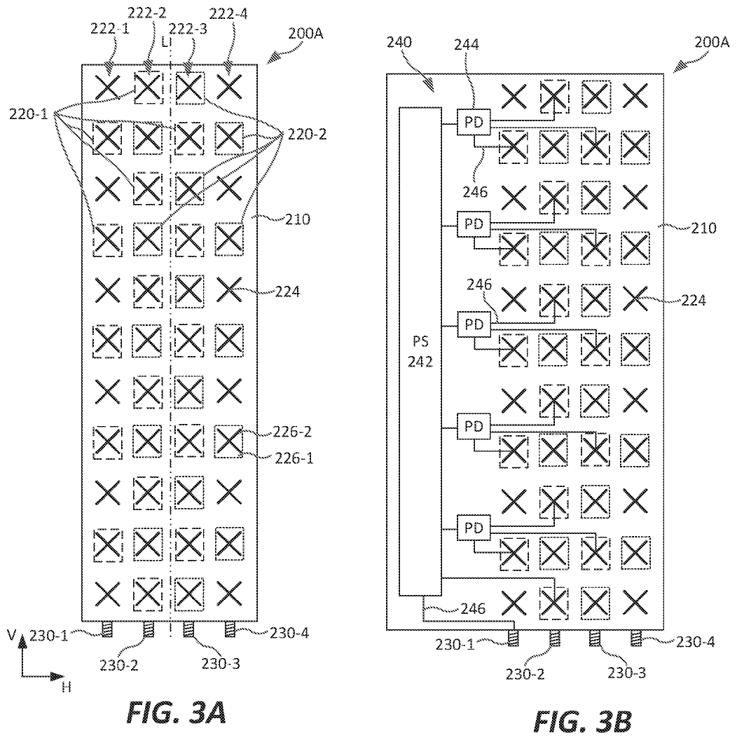

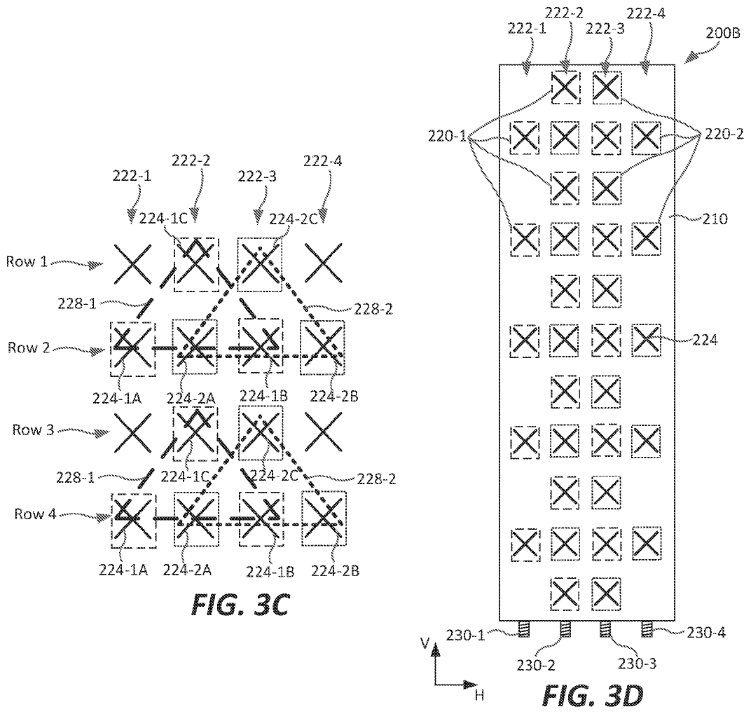

The base station antenna 100 further includes four RF ports 130-1 through 1304. Each RF port 130 may have a connector interface that allows the RF port 130 to connect to a port of an external radio (e.g., via a coaxial cable). Each RF port 130 is connected to a respective one of first through fourth feed networks (not shown) that connect each RF port 130 to selected ones of the dipole radiators 126 of the radiating elements 124. In particular, the first feed network may connect the first RF port 130-1 to the first dipole radiators 126-1 of the first radiating elements 124-1 that form the first array 120-1, and the third feed network may connect the third RF port 130-3 to the second dipole radiators 126-2 of the first radiating elements 124-1 that form the first array 120-1. Similarly, the second feed network may connect the second RF port 130-2 to the first dipole radiators 126-1 of the second radiating elements 124-2 that form the second array 120-2, and the fourth feed network may connect the fourth RF port 130-4 to the second dipole radiators 126-2 of the second radiating elements 124-2 that form the second array 120-2. Each feed network may include, for example, power dividers and electromechanical phase shifters that sub-divide RF signals received at an RF port 130 that is connected to the feed network into a plurality of sub-components, apply a phase progression to the sub-components of the RF signal, and feed the sub-components to individual radiating elements 124 (or groups thereof). The feed networks are not depicted in FIG. 2, but a similar feed network is depicted in FIG. 3B that illustrates how an RF port may be connected to first polarization radiators of the radiating elements of an array.

The base station antenna 100 will generate a radiation pattern or “antenna beam” in response to an RF signal input at each RF port 130. Thus, base station antenna 100 may simultaneously generate four antenna beams by simultaneously inputting RF signals at each of the four RF ports 130-1 through 130-4. The first radiating elements 124-1 and the second radiating elements 124-2 may have identical designs in some embodiments.

As described above, the azimuth HPBW of an antenna beam generated by an array of radiating elements will be a function of (1) the azimuth beamwidth of the element patterns generated by each radiating element in the array and (2) the extent that the radiating elements in the array are spaced apart in the azimuth plane (the “aperture” of the array in the azimuth plane). Typically, radiating elements for base station antennas are designed to generate element patterns that have an azimuth HPBW of about 65° so that a single vertically-extending column of radiating elements will generate an antenna beam having an azimuth HPBW of about 659, which is a suitable antenna beam shape for covering a 120° sector of a base station. The conventional narrow-beam base station antenna 1 of FIG. 1 couples each RF port 30 to three columns 22 of radiating elements 24, which increases the aperture of the array in the azimuth plane. As a result, the antenna beams generated by the first and second arrays of radiating elements 20-1, 20-2 in the conventional base station antenna 1 of FIG. 1 may have an azimuth HPBW of about 33°.

The base station antenna 100 takes a different approach to generate antenna beams having narrowed azimuth HPBWs. In particular, antenna 100 is designed so that the top nine radiating elements 124 in the first and second columns 122-1, 122-2 and the bottom two radiating elements 124 in the third and fourth columns 122-3, 122-4 are first radiating elements 124-1 that form the first array 120-1. Similarly, the top nine radiating elements 124 in the third and fourth columns 122-3, 122-4 and the bottom two radiating elements 124 in the first and second columns 122-1, 122-2 are second radiating elements 124-2 that form the second array 120-2. Since radiating elements 124 in all four columns are part of each array 120-1, 120-2, the azimuth HPBW is narrowed. However, since all but four of the radiating elements 124 in each array 120-1, 120-2 are in two adjacent columns 122, there are only a few radiating elements 124 that assist in narrowing the azimuth HPBW beyond that which would be achieved with an array that simply consisted of two adjacent columns of radiating elements. The base station antenna of FIG. 2 may form antenna beams having azimuth HPBWs of about 34° at a center frequency of the operating frequency band of the radiating elements 124. However, the antenna beams formed by base station antenna 100 may exhibit higher grating lobes and have some degree of distortion in the main lobe. As a result, the directivity (gain) of base station antenna 100 may be lower than that of base station antenna 1, and the 10 dB azimuth beamwidth of the antenna beams of antenna 100 may be wider than the corresponding 10 dB azimuth beamwidths of the conventional base station antenna 1, resulting in reduced sector power ratios.

More generally, the base station antenna 100 includes a plurality of radiating elements 124 that are arranged in first through fourth vertically-extending columns 122-1 through 122-4 that are positioned in numerical order. The radiating elements 124 are also aligned in a plurality or “X” horizontally-extending rows (here X=11) that are positioned in numerical order. The radiating elements 124 form a first array 120-1 and a second array 120-2. The first array 120-1 comprises all of the radiating elements 124 in the first X-Y rows of the first and second vertically extending columns 222-1, 222-2 (here Y=2), and all of the radiating elements 124 in the last Y rows of the third and fourth vertically-extending columns 222-3, 222-4. The second array comprises all of the radiating elements 124 in the first X-Y rows of the third and fourth vertically extending columns 222-3, 222-4 and all of the radiating elements 124 in the last Y rows of the first and second vertically-extending columns 222-1, 222-2.

FIG. 3A is a schematic front view of a base station antenna 200A according to embodiments of the present invention. The base station antenna 200A includes four columns 222-1 through 222-4 of radiating elements 224. The columns 222 are arranged side-by-side with the first and fourth columns 222-1, 222-4 comprising outer columns and the second and third columns 222-2, 222-3 comprising inner columns. The radiating elements 224 are mounted to extend forwardly from a reflector 210. The reflector 210 may, in example embodiments, comprise a sheet of metal that serves as a ground plane for the radiating elements 224 and that also redirects forwardly much of the backwardly-directed radiation emitted by the radiating elements 224. The radiating elements 224 may comprise, for example, mid-band radiating elements that are configured to operate in some or all of the 1427-2690 MHz frequency band. Each radiating element 224 may comprise, for example, a −45°/+45° cross-dipole radiating element that has a first dipole radiator 226-1 that extends at an angle of 45° with respect to a longitudinal axis L of the antenna 200A and a second dipole radiator 226-2 that extends at an angle of +45° with respect to the longitudinal axis L of the antenna 200A. Each column 222 may extend along an axis that is parallel to the longitudinal axis L of the base station antenna 200A and hence may be a vertically-extending column of radiating elements when the base station antenna 200A is mounted without any mechanical downtilt. The columns 222 may be spaced apart from each other in the horizontal direction H.

The radiating elements 224 include first radiating elements 224-1 and second radiating elements 224-2. The first radiating elements 224-1 form a first array 220-1, and the second radiating elements 224-2 form a first array 220-2. As noted above, in the figures the first radiating elements 224-1 that are part of the first array 220-1 are shown using dashed-line boxes, while the second radiating elements 224-2 that are part of the second array 220-2 are shown using dotted-line boxes. The radiating elements 224 that are not part of either array 220-1, 220-2 are not enclosed by any box.

The base station antenna 200A further includes four RF ports 230-1 through 230-4. Each RF port 230 may have a connector interface that allows the RF port 230 to connect to a port of an external radio (e.g., via a coaxial cable). Each RF port 230 is connected to a respective one of four feed networks 240 (see FIG. 3B) that connect each RF port 230 to selected ones of the dipole radiators 226 of the radiating elements 224. The first of the feed networks 240 may connect the first RF port 230-1 to the first dipole radiators 226-1 of the first radiating elements 224-1 that form the first array 220-1, and the third of the feed networks 240 may connect the third RF port 230-3 to the second dipole radiators 226-2 of the first radiating elements 224-1 that form the first array 220-1. Similarly, the second of the feed networks 240 may connect the second RF port 230-2 to the first dipole radiators 226-1 of the second radiating elements 224-2 that form the second array 220-2, and the fourth of the feed networks 240 may connect the fourth RF port 230-4 to the second dipole radiators 226-2 of the second radiating elements 224-2 that form the second array 220-2.

FIG. 3B is a schematic front view of the base station antenna of FIG. 3A that further illustrates one of the four feed networks 240. As shown in FIG. 3B, the feed network 240 includes a phase shifter (PS) 242, a plurality of 1×3 power dividers (PD) 244, and a plurality of RF transmission lines 246 that may be implemented, for example, using coaxial cables. As shown, an RF transmission line 246 connects RF port 230-1 to an electromechanical phase shifter 242. The phase shifter 242 sub-divides RF signals received from RF port 230 into a plurality of sub-components and applies a phase progression or “taper” to the sub-components of the RF signal. The phase tapered sub-components of the RF signal are output at the six output ports of the phase shifter 242. Five of the phase shifter output ports are connected to respective 1×3 power dividers 244 that further sub-divide each sub-component of the RF signal. The further divided sub-component of the RF signal output through the output port of each power divider 244 is passed to first polarization radiators 226-1 of respective first radiating elements 224-1. The sixth output of the phase shifter 242 is connected directly to the first polarization radiator 226-1 of the final first radiating element 224-1 included in the first array 220-1. The second through fourth feed networks 240 may have the same design, and are not shown in FIG. 3B to simplify the drawing.

The base station antenna 200A will generate an antenna beam in response to an RF signal input at each of the RF ports 230. Thus, base station antenna 200A may simultaneously generate four antenna beams by simultaneously inputting RF signals at each of the four RF ports 230-1 through 230-4. The first radiating elements 224-1 and the second radiating elements 224-2 may have identical designs in some embodiments. In some embodiments, a number of first radiating elements 224-1 in the first array 220-1 may be equal to a number of second radiating elements 224-2 in the second array 220-2.

The first array 220-1 includes a plurality of triangular arrangements 228-1 of first radiating elements 224-1, and the second array 220-2 includes a plurality of triangular arrangements 228-2 of second radiating elements 224-2. This is best shown in FIG. 3C, which is an enlarged view of the top four rows (labelled Row 1 through Row 4) of radiating elements 224-1, 224-2 illustrated in FIG. 3A. As shown in FIG. 3C, the first array 220-1 includes a first triangular arrangement 228-1 of first radiating elements 224-1, that consists of the three first radiating elements 224-1 that are in Rows 1 and 2, and a second triangular arrangement 228-1 of first radiating elements 224-1, that consists of the three first radiating elements 224-1 that are in Rows 3 and 4. Similarly, the second array 220-2 includes a first triangular arrangement 228-2 of second radiating elements 224-2, that consists of the three second radiating elements 224-2 that are in Rows 1 and 2, and a second triangular arrangement 228-2 of second radiating elements 224-2, that consists of the three second radiating elements 224-2 that are in Rows 3 and 4.

The first array 220-1 includes a total of five triangular arrangements 228-1 of first radiating elements 224-1, as well as a sixth partial triangular arrangement 228-1, and the second array 220-2 includes a total of five triangular arrangements 228-2 of second radiating elements 224-2, as well as a sixth partial triangular arrangement 228-2. The five triangular arrangements 228-1 of first radiating elements 224-1 are vertically stacked, and the five triangular arrangements 228-2 of second radiating elements 224-2 are similarly vertically stacked. Herein, the term “vertically-stacked triangular arrangements of radiating elements” refers to at least two groups of three radiating elements, where the radiating elements in each group form a triangle, and the triangles defined by the two or more groups of three radiating elements are stacked along a vertical direction when the base station antenna is oriented so that the longitudinal axis of the antenna extends vertically. As can be seen in FIG. 3C, each triangular arrangement 228 of radiating elements 224 includes three radiating elements, where each radiating element 224 is in a different one of the columns 222.

As is further shown in FIG. 3C, each triangular arrangement 228-1 of first radiating elements 224-1 in the first array 220-1 is interleaved with a respective one of the triangular arrangements 228-2 of second radiating elements 224-2 of the second array 220-2. In particular, each triangular arrangement 228-1 of first radiating elements 224-1 in the first array 220-1 includes a pair of first radiating elements 224-1A, 224-1B that are horizontally-aligned with each other and a single first radiating element 224-1C that is vertically offset from the horizontally-aligned pair of first radiating elements 224-1A, 224-1B. Each triangular arrangement 228-2 of second radiating elements 224-2 in the second array 220-2 similarly includes a pair of second radiating elements 224-2A, 224-2B that are horizontally-aligned with each other and a single second radiating element 224-2C that is vertically offset from the horizontally-aligned pair of second radiating elements 224-2A, 224-2B. The first radiating element 224-1B of each triangular arrangement 228-1 of first radiating elements 224-1 are positioned between two second radiating elements 224-2A, 224-2B of an adjacent triangular arrangement 228-2 of second radiating elements 224-2. Thus, the first and second arrays 220-1, 220-2 are “interleaved” in that first radiating elements 224-1 of the first array 220-1 is positioned between two second radiating elements 224-2 of the second array 220-2.

Notably, the interleaving occurs in both the horizontal and vertical directions. For example, with reference to Rows 1-3 of FIG. 3C, it can be seen that the second radiating element 224-2A in Row 2 is directly between a pair of first radiating elements 224-1A, 224-1B in the horizontal direction and is also directly between a pair of first radiating elements 224-1 in the vertical direction, namely radiating element 224-1C in Row 1 and radiating element 224-1C in Row 3.

As can be seen in FIG. 3A, the first array 220-1 includes one first radiating element 224-1 in Row 1, two first radiating elements 224-1 in Row 2, one first radiating element 224-1 in Row 3, two first radiating elements 224-1 in Row 4, etc. The second array 220-2 similarly includes one second radiating element 224-2 in Row 1, two second radiating elements 224-2 in Row 2, one second radiating element 224-2 in Row 3, two second radiating elements 224-2 in Row 4, etc. Together, the first and second arrays 220-1, 220-2 include two radiating elements 224 in Row 1, four radiating elements 224 in Row 2, two radiating elements 224 in Row 3, four radiating elements 224 in Row 4, etc. Base station antenna 200A also includes twelve radiating elements 224 that are not part of either the first array 220-1 or the second array 220-2. In some embodiments, these radiating elements 224 may not be connected to any of the RF ports 230 and may be inactive “dummy” radiating elements.

Referring again to FIG. 3A, it can be seen that the first radiating elements 224-1 that form the vertically-stacked triangular arrangements 228-1 of first radiating elements 224-1 are located exclusively in the first through third vertically-extending columns 222-1, 222-2, 222-3, and the second radiating elements 224-2 that form the vertically-stacked triangular arrangements 228-2 of second radiating elements 224-2 are located exclusively in the second through fourth vertically-extending columns 222-2, 222-3, 222-4. It can also be seen that all of the rows include a first radiating element 224-1 that is located in either the second column 222-2 or the third column 222-3 (i.e., in an inner column 222) and a second radiating element 224-2 that is located in the other of the second column 222-2 or the third column 222-3.

Each row of an array 220 that includes a single radiating element 224 will generate an antenna beam that has an azimuth HPBW of about 65°. Each row of an array 220 that includes two radiating elements 224 will generate an antenna beam that has an azimuth HPBW of about 20° since the two radiating elements 224 are spaced apart by about a wavelength corresponding to the center frequency of the operating frequency band of the radiating elements 224. The average azimuth HPBW (across the operating frequency band) of the antenna beams generated by each array 220 is about 37.8°.

The base station antenna 200A may simultaneously generate four antenna beams (one antenna beam at each of two polarizations for each of the two arrays 220) that have an azimuth HPBW of less than 40° (e.g., about 38°) when transmitting at the center frequency of the operating frequency band of the radiating element 224. The base station antenna 200A only includes four columns 222 of radiating elements since the radiating elements 224 of the first and second arrays are interleaved with each other.

FIG. 3D is a schematic front view of a base station antenna 200B according to further embodiments of the present invention. Base station antenna 200B is very similar to base station antenna 200A of FIG. 3A, so the discussion below will focus on the differences between the two antennas. As can be seen by comparing FIGS. 3A and 3D, base station antenna 200B differs from base station antenna 200A in that the twelve “dummy” radiating elements 224 of base station antenna 200A that are not part of either the first or second arrays 220-1, 220-2 are omitted in base station antenna 200B for cost and weight reduction purposes. As a result, the second and third columns 222-2, 222-3 in base station antenna 200B have more radiating elements 224 than do either the first or fourth columns 222-1, 222-4. In particular, the first column 222-1 includes (5) first radiating elements 224-1 and (0) second radiating elements 224-2, the second column 222-2 includes (6) first radiating elements 224-1 and (5) second radiating elements 224-2, the third column 222-3 includes (5) first radiating elements 224-1 and (6) second radiating elements 224-2, and the fourth column 222-4 includes (0) first radiating elements 224-1 and (5) second radiating elements 224-2. As such, a sum of the number of first radiating elements 224-1 and the number of second radiating elements 224-2 in either the first column 222-1 (5) or the fourth column 222-4 (5) is less than a sum of a number of first radiating elements 224-1 and a number of second radiating elements 224-2 in the second column 222-1 (11) and in the third column 222-3 (11). Likewise, a total number of first and second radiating elements 224-1, 224-2 in the second and third columns 222-2, 222-3 (22) is at least three times, and in fact more than four times a total number of first and second radiating elements 224-1, 224-2 in either the first column 222-1 or the fourth column 222-4 (5 each).

Otherwise, base station antenna 200B may be identical to base station antenna 200A, and thus further description thereof will be omitted.

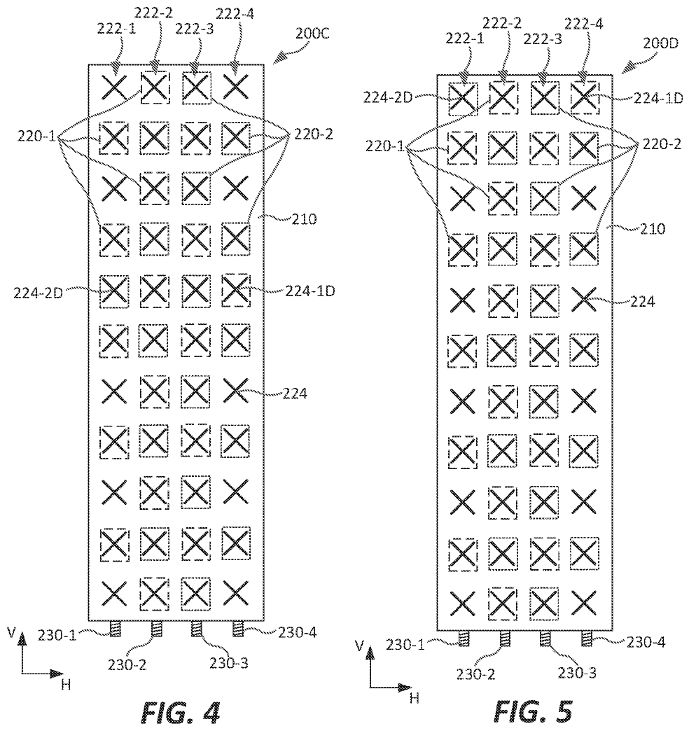

FIG. 4 is a schematic front view of a base station antenna 200C according to further embodiments of the present invention. Base station antenna 200C is similar to base station antenna 200A of FIG. 3A, so the discussion below will focus on the differences between the two antennas. As can be seen by comparing FIGS. 3A and 4, base station antenna 200C differs from base station antenna 200A in that a first of the “dummy” radiating elements 224 of base station antenna 200A is converted to a first radiating element 224-1D that is part of the first array 220-1 and a second of the “dummy” radiating elements 224 of base station antenna 200A is converted in base station antenna 200C into a second radiating element 224-2D that is part of the second array 220-2. This may be accomplished by connecting radiating element 224-1D to the first and third of the feed networks 240 (and hence to the first and third RF ports 230-1, 230-3) and by connecting radiating element 224-2D to the second and fourth of the feed networks 240 (and hence to the second and fourth RF ports 230-2, 230-4). The two “dummy” radiating elements 224 of base station antenna 200A that are converted into first radiating element 224-1D and second radiating element 224-2D are located at or near the center of base station antenna 200C in the longitudinal dimension of the antenna. Thus, the first array 220-1 includes one “extra” first radiating element 224-1 that is not part of the plurality of vertically-stacked triangular arrangements 228-1 of first radiating elements 224-1, and the second array 220-2 includes one “extra” second radiating element 224-2 that is not part of the plurality of vertically-stacked triangular arrangements 228-2 of second radiating elements 224-2. In some embodiments, a total number of extra first radiating elements 224-1 may be either one or two, and a total number of extra second radiating elements 224-2 may also be either one or two.

The dummy radiating element 224 of base station antenna 200A that is converted into first radiating element 224-1D is located in the fourth column 222-4. Thus, the addition of this extra first radiating element 224-1D to the first array 220-1 has a significant impact on the azimuth HPBW of the antenna beams generated by the first array 220-1, as the addition of first radiating element 224-1D expands the extent of the first array 220-1 by a half wavelength in the horizontal dimension (which dimension corresponds to the azimuth plane). Similarly, the dummy radiating element 224 that is converted into second radiating element 224-2D is located in the first column 222-1. Thus, the addition of this extra second radiating element 224-2D to the second array 220-2 similarly has a significant impact on the azimuth HPBW of the antenna beams generated by the second array 220-2. Adding an extra radiating element 224 to each of the first and second arrays 220-1, 220-2 in a column that otherwise does not include any other radiating elements of the respective first and second arrays 220-1, 220-2 acts to significantly narrow the average azimuth HPBW to 33.4°, and the additional radiating elements also increase the directivity of the antenna 200C as compared to antenna 200A. While not shown in the figures, in a modified version of base station antenna 200C the ten dummy radiating elements may be omitted for cost and weight reduction purposes. It will be appreciated that some or all of the unused dummy radiating elements may be omitted from all of the base station antennas according to embodiments of the present invention disclosed herein.

FIG. 5 is a schematic front view of a base station antenna 200D according to further embodiments of the present invention. Base station antenna 200D is similar to base station antennas 200A and 200C that are discussed above, so the discussion below will focus on the differences between the two antennas. As can be seen by comparing FIGS. 3A and 5, base station antenna 200D differs from base station antenna 200A in that a first of the “dummy” radiating elements 224 of base station antenna 200A is converted into a first radiating element 224-1D that is part of the first array 220-1 and a second of the “dummy” radiating elements 224 is converted into a second radiating element 224-2D that is part of the second array 220-2. As can be seen by comparing FIGS. 4 and 5, base station antenna 200D differs from base station antenna 200C in that the two “dummy” radiating elements 224 of base station antenna 200A that are added to the respective first and second arrays 220-1, 220-2 are radiating elements that are in the top row of radiating elements as opposed to radiating elements that are located at or near the center of base station antenna as was the case with base station antenna 200C. It will be appreciated that in other embodiments the two “dummy” radiating elements 224 of base station antenna 200A that are added to the respective first and second arrays 220-1, 220-2 could be dummy elements that are in the bottom row instead of the top row. Adding an extra radiating element 224 in the top (or bottom) row to each of the first and second arrays 220-1, 220-2 again narrows the average azimuth HPBW and increases the directivity of the antenna. While not shown in the figures, in another modified version of base station antenna 200D the ten dummy radiating elements may be omitted for cost and weight reduction purposes.

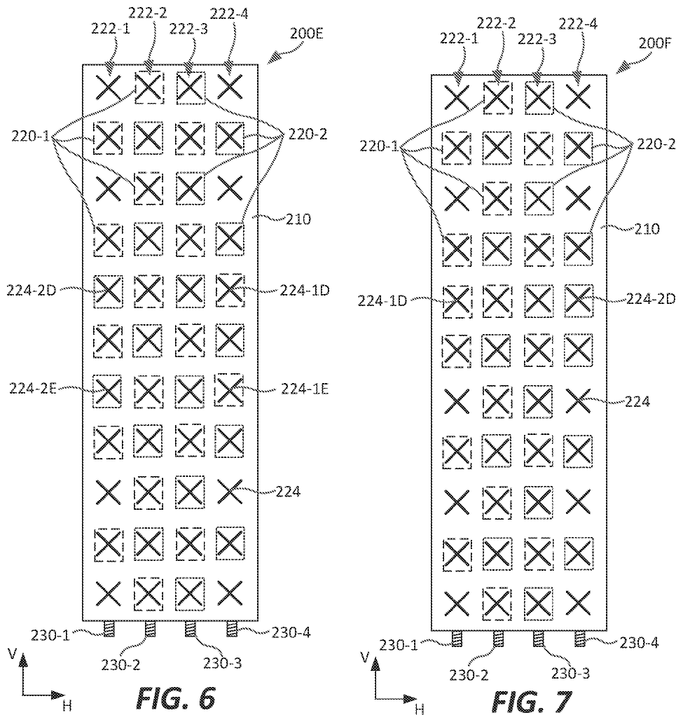

FIGS. 6-9 are schematic front views of base station antennas according to still further embodiments of the present invention.

Referring first to FIG. 6, a base station antenna 200E is shown that has two interleaved arrays 220-1, 220-2 that each comprise vertically-stacked triangular arrangements 228 of radiating elements 224, where each array 220-1, 220-2 further includes two additional radiating elements that are added in the middle of the array. In other words, base station antenna 200E is very similar to base station antenna 200C of FIG. 4, except that in base station antenna 200E two of the “dummy” radiating elements 224 of base station antenna 200A are converted into first radiating elements 224-1D, 224-1E that are part of the first array 220-1 and another two of the “dummy” radiating elements 224 are converted into second radiating elements 224-2D, 224-2E that are part of the second array 220-2, whereas in base station antenna 200B only one “dummy” radiating element 224 is added to each array 220-1, 220-2. Like base station antenna 200C, the dummy radiating elements 224 that are added to the arrays 220-1, 220-2 are located at or near the center of base station antenna 200D in the longitudinal dimension of the antenna. Adding a second dummy radiating element 224 to each array 220 acts to further narrow the average azimuth HPBW and provides a small additional increase in directivity. While not shown in the figures, in a modified version of base station antenna 200E the eight dummy radiating elements may be omitted for cost and weight reduction purposes.

Referring first to FIG. 7, a base station antenna 200F is shown that is similar to base station antenna 200C of FIG. 4, except that the “dummy” radiating elements 224 that are “added” to the first and second arrays 220-1, 220-2 are swapped so that the dummy radiating element 224 in the first column 222-1 is converted into a first radiating element 224-1D that is part of the first array 220-1, and the dummy radiating element 224 in the fourth column 222-4 is converted into a second radiating element 224-2D that is part of the second array 220-2. Since in base station antenna 200F the first and second dummy radiating elements 224 that are converted into respective first and second radiating elements 224-1, 224-2 are in the same columns 222 as other of the radiating elements of the respective first and second arrays 220-1, 220-2, the antenna beams generated by base station antenna 200F have wider azimuth HPBWs as compared to the antenna beams generated by base station antenna 200C. The azimuth HPBW of base station antenna 200F will be slightly narrower than the azimuth HPBW of base station antenna 200A.

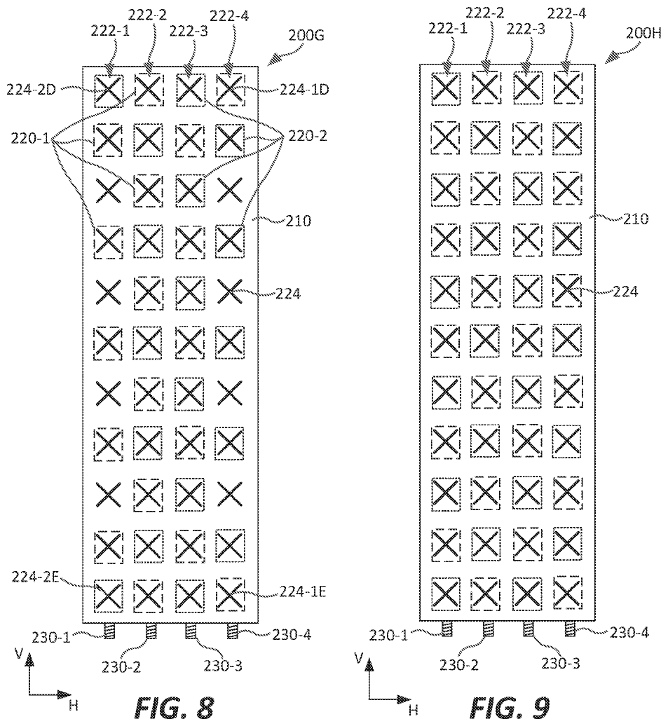

FIG. 8 is a schematic front view of a base station antenna 200G that is similar to base station antenna 200D of FIG. 5, except that in base station antenna 200G two additional dummy radiating elements that are located in the bottom row of radiating elements are converted into first and second radiating elements 224-1E, 224-2E that are part of the respective first and second arrays 220-1, 220-2. This change acts to further narrow the azimuth HPBW of the antenna beams generated by base station antenna 200G and slightly increases the directivity of those antenna beams.

FIG. 9 is a schematic front view of a base station antenna 200H according to still further embodiments of the present invention. In base station antenna 200H, half of the “dummy” radiating elements 224 of base station antenna 200A are converted into first radiating elements 224-1 that are part of a first array and the other half of the dummy radiating elements are converted into second radiating elements 224-2 that are part of a second array. As a result, in base station antenna 200H all of the radiating elements are part of either the first array or the second array, and the first and second radiating elements 224-1, 224-2 of the respective first and second arrays are interleaved in a checkerboard arrangement.

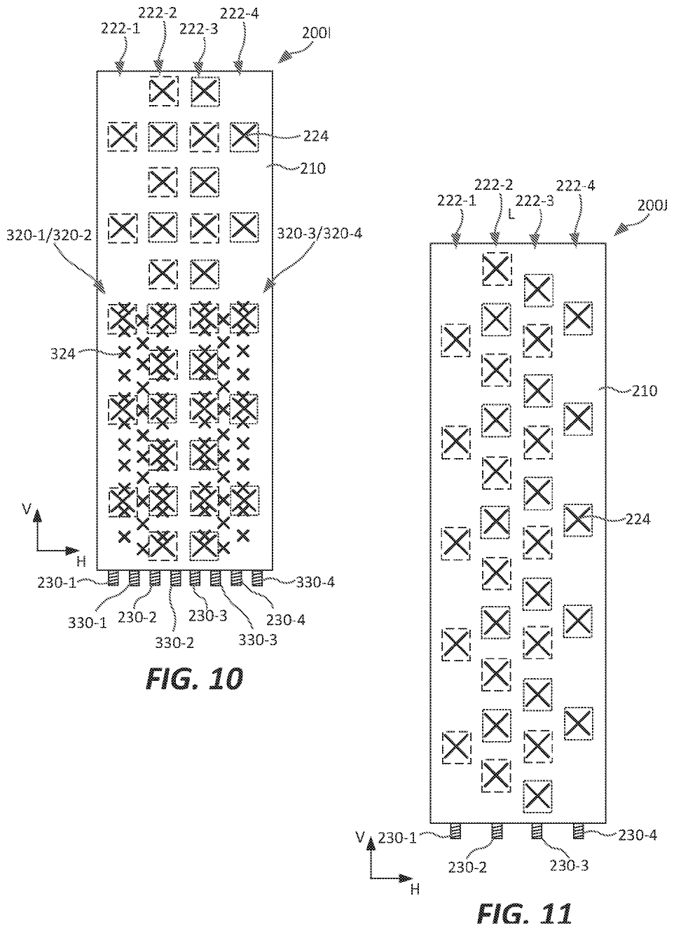

FIG. 10 is a schematic front view of a multiband base station antenna 200I according to embodiments of the present invention. Base station antenna 200I is similar to base station antenna 200B of FIG. 3D, except that base station antenna 200I also includes additional arrays 320-1, 320-2 of radiating elements 324, along with associated RF ports 330-1 through 330-4 and associated feed networks (not shown).

The radiating elements 324 may comprise, for example, high-band −45°/+45° cross-dipole radiating elements that are configured to operate in some or all of the 3100-4200 MHz frequency band. The radiating elements 324 may be arranged in four arrays 320-1 through 320-4. Arrays 320-1 and 320-2, which are on the left side of the antenna 200I, may be identical to arrays 220-1 and 220-2 of base station antenna 200B, except that 320-1 and 320-2 are formed using high-band radiating elements 324 instead of mid-band radiating elements 224. Arrays 320-3 and 320-4, which are on the right side of the antenna 200I, may also be identical to arrays 220-1 and 220-2 of base station antenna 200B, except that 320-3 and 320-4 are formed using high-band radiating elements 324 instead of mid-band radiating elements 224. It will be appreciated that high-band arrays 320-1 through 320-4 may be added to any of the base station antennas according to embodiments of the present invention, and that the high-band arrays 320-1 through 320-4 may have the design of any of the mid-band arrays 220-1, 220-2 discussed above.

While not shown in the drawings, isolation fences may be provided between adjacent columns of radiating elements and/or between adjacent rows of radiating elements in any of the base station antennas according to embodiments of the present invention. The isolation walls may comprise metal or metal-plated walls that extend forwardly from the reflector that are configured to reduce the amount that radiating elements in a first array emit RF energy that is incident on adjacent radiating elements that are part of another array. Since the base station antennas according to embodiments of the present invention have interleaved arrays, the use of such isolation structures may be particularly helpful for reducing interaction between the arrays.

In example embodiments, the center-to-center distance between the radiating elements 224 in adjacent columns 222 may be about one half of a wavelength corresponding to a center frequency of the operating frequency band of the array 220. In other embodiments, this spacing may be changed. For example, a spacing of greater than 0.5 wavelengths may be used (e.g., 0.53-0.65 wavelengths) may be used to increase the isolation between the arrays and/or to increase the amount of decorrelation between the arrays for improved MIMO performance.

Pursuant to further embodiments of the present invention, narrow-beam base station antennas are provided that include two interleaved arrays of dual-polarized radiating elements where the radiating elements are arranged in staggered columns. In some situations, multi-column arrays of radiating elements are implemented where adjacent columns are offset from each other by about half the vertical distance between radiating elements in a column. This vertical offset helps increase the physical distance between radiating elements in adjacent columns, and hence may improve isolation. The same technique may be used in any of the base station antennas according to embodiments of the present invention. For example, FIG. 11 schematically illustrates a base station antenna 200J which is identical to base station antenna 200B of FIG. 3D except that in base station antenna 200J adjacent columns are offset from each other vertically in the manner described above. As can be seen from FIG. 11, base station antenna 200J includes a plurality of vertically-stacked triangular arrangements 228-1 of first radiating elements 224-1 and a plurality of vertically-stacked triangular arrangements 228-2 of second radiating elements 224-2 that are interleaved with each other.

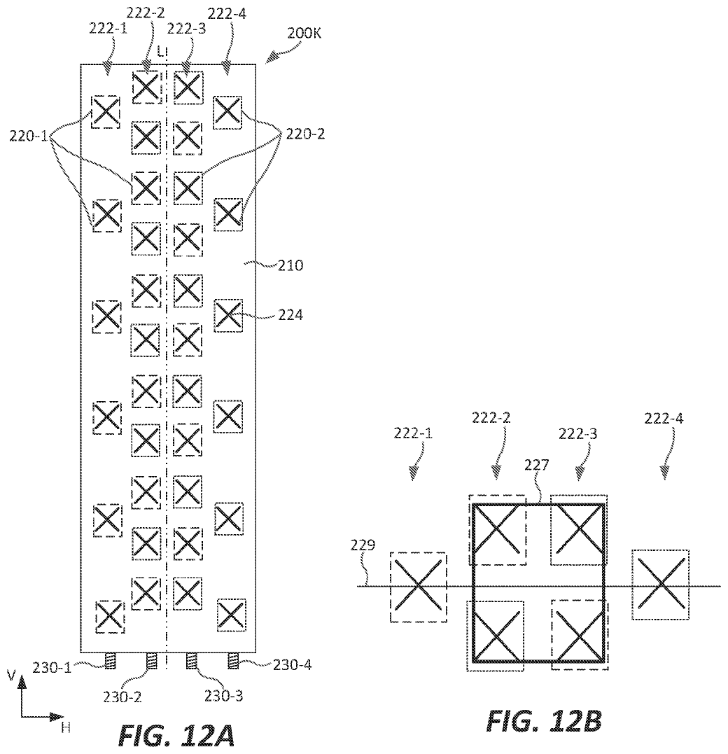

FIG. 12A is a schematic front view of a base station antenna 200K according to further embodiments of the present invention that illustrates an alternative approach to vertically-staggering the columns of radiating elements. In the embodiment shown in FIG. 12A, the first and fourth columns 222-1 and 222-4 are staggered in the vertical direction with respect to the second and third columns 222-3 and 222-4. The first array 220-1 again comprises a plurality of vertically-stacked triangular arrangements 228-1 of first radiating elements 224-1, and the second array 220-2 also comprises a plurality of vertically-stacked triangular arrangements 228-2 of second radiating elements 224-2. However, in base station antenna 200K, the “bottom” two radiating elements of each of the triangular arrangements 228 of radiating elements 224 are no longer horizontally-aligned, and hence the triangular arrangements 228 are tilted with respect to the longitudinal axis L of the antenna 200K.

As can be seen in FIG. 12A, base station antenna 200K includes a plurality of “sub-arrays” of radiating elements that are vertically-stacked along the longitudinal axis L of the antenna. FIG. 12B is an enlarged view of a portion of the base station antenna 200K that illustrates the radiating elements 224-1, 224-2 of one of these sub-arrays. As shown in FIG. 12B, the radiating elements 224 in columns 222-2 and 222-3 are positioned in a rectangular arrangement 227, with two first radiating elements 224-1 defining one of the diagonals of the rectangle 227 and with two second radiating elements 224-2 defining the other diagonal of the rectangle 227. Thus, the first and second radiating elements 224-1, 224-2 that are included in the second and third vertically-extending columns 222-2, 222-3 are arranged as a plurality of vertically-stacked rectangular arrangements 227 of first and second radiating elements 224-1, 224-2. The first vertically-extending column 222-1 includes a plurality of first radiating elements 224-1 that are vertically offset with respect to all of the first and second radiating elements 224-1, 224-2 in the second and third vertically-extending columns 222-2, 222-3. Similarly, the fourth vertically-extending column 222-4 includes a plurality of second radiating elements 224-2 that are vertically offset with respect to all of the first and second radiating elements 224-1, 224-2 in the second and third vertically-extending columns 222-2, 222-3.

Each first radiating element 224-1 in the first vertically-extending column 222-1 is horizontally aligned with a respective second radiating element 224-2 in the fourth vertically-extending column 222-4 to form a plurality of horizontally aligned pairs of radiating elements 224-1, 224-2. Each first radiating element 224-1 in column 222-1 is horizontally aligned with a respective one of the second radiating elements in column 222-4 along respective horizontal lines 229 that each pass through a central region of a respective one of the plurality of vertically-stacked rectangular arrangements 227 of first and second radiating elements 224-1, 224-2. As in other of the embodiments described above, a sum of a number of first radiating elements 224-1 and a number of second radiating elements 224-2 in the second column 222-2 is at least 50% more than a sum of a number of first radiating elements 224-1 and a number of second radiating elements 224-2 in the first column 222-1. The first and second arrays 220-1, 220-2 may each generate antenna beams having azimuth HPBWs of less than 40° (e.g., of about 33° or less).

It will be appreciated that many modifications may be made from the above-described example embodiments without departing from the scope of the present invention. For example, the number of rows of radiating elements may be varied from that which is shown. As another example, “extra” radiating elements may be added in different or additional positions to either the first or second arrays 220-1, 220-2. As another example, while the embodiments above use −45°/+45° cross-dipole radiating elements, it will be appreciated that in other embodiments different types of radiating elements may be used such as, for example, patch radiating elements, slot radiating elements, horn radiating elements or any other suitable radiating element, and these radiating elements may be single polarized or dual-polarized radiating elements.

It will be appreciated that the present specification only describes a few example embodiments of the present invention and that the techniques described herein have applicability beyond the example embodiments described above.

Embodiments of the present invention have been described above with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

Herein, the term “substantially” refers to variation of less than 10%.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “on” another element, it can be directly on the other element or intervening elements may also be present. In contrast, when an element is referred to as being “directly on” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, operations, elements, and/or components, but do not preclude the presence or addition of one or more other features, operations, elements, components, and/or groups thereof.

Aspects and elements of all of the embodiments disclosed above can be combined in any way and/or combination with aspects or elements of other embodiments to provide a plurality of additional embodiments.

1. A base station antenna, comprising:
a reflector;
a first radio frequency (“RF”) port having a plurality of first radiating elements coupled thereto that form a first array, each of the first radiating elements extending forwardly from the reflector;
a second RF port having a plurality of second radiating elements coupled thereto that form a second array, each of the second radiating elements extending forwardly from the reflector,
wherein at least some of the first radiating elements are arranged as a plurality of vertically-stacked triangular arrangements of first radiating elements,
wherein at least some of the second radiating elements are arranged as a plurality of vertically-stacked triangular arrangements of second radiating elements, and
wherein one of the first radiating elements in a first of the triangular arrangements of first radiating elements is positioned between two of the second radiating elements in a first of the triangular arrangements of second radiating elements.

2. The base station antenna of claim 1, wherein one of the second radiating elements in the first of the triangular arrangements of second radiating elements is positioned between two of the first radiating elements in the first of the triangular arrangements of first radiating elements.

3. The base station antenna of claim 2, wherein another one of the second radiating elements in the first of the triangular arrangements of second radiating elements is positioned directly above the one of the first radiating elements in the first of the triangular arrangements of first radiating elements.

4. The base station antenna of claim 3, wherein another one of the first radiating elements in the first of the triangular arrangements of first radiating elements is positioned directly above the one of the second radiating elements in the first of the triangular arrangements of second radiating elements.

5. The base station antenna of claim 1, wherein the one of the first radiating elements in the first of the triangular arrangements of first radiating elements and the two of the second radiating elements in the first of the triangular arrangements of second radiating elements are all horizontally aligned with each other.

6. The base station antenna of claim 1, wherein the first and second radiating elements are arranged in first through fourth vertically-extending columns that are positioned in numerical order.

7. The base station antenna of claim 6, wherein the first radiating elements that form the vertically-stacked triangular arrangements of first radiating elements are located exclusively in the first through third vertically-extending columns, and the second radiating elements that form the vertically-stacked triangular arrangements of second radiating elements are located exclusively in the second through fourth vertically-extending columns.

8. The base station antenna of claim 6, wherein a sum of a number of first radiating elements and a number of second radiating elements in the first column is less than a sum of a number of first radiating elements and a number of second radiating elements in the second column.

9-10. (canceled)

11. The base station antenna of claim 6, wherein one or more of the first radiating elements are extra first radiating elements that are not part of the plurality of vertically-stacked triangular arrangements of first radiating elements, and one or more of the second radiating elements are extra second radiating elements that are not part of the plurality of vertically-stacked triangular arrangements of second radiating elements.

12. (canceled)

13. The base station antenna of claim 11, wherein the first through fourth vertically-extending columns define a plurality of rows, and wherein the extra first radiating elements and the extra second radiating elements are all located in the top two rows and/or the bottom two rows of the plurality of rows.

14-15. (canceled)

16. A base station antenna, comprising:
a first radio frequency (“RF”) port having a plurality of first radiating elements coupled thereto that form a first array, the first array configured to generate an antenna beam having a half power beamwidth in the azimuth plane of less than 40° in response to a first RF signal having a frequency equal to a center frequency of an operating frequency band of the first array that is input at the first RF port;
a second RF port having a plurality of second radiating elements coupled thereto that form a second array, the second array configured to generate an antenna beam having a half power beamwidth in the azimuth plane of less than 40° in response to a second RF signal having a frequency equal to a center frequency of an operating frequency band of the second array that is input at the second RF port;
wherein the first and second radiating elements are arranged in first through fourth vertically-extending columns that are positioned in numerical order,
wherein the second and third columns each include respective total numbers of first and second radiating elements that exceeds respective total numbers of first and second radiating elements in either the first column or the fourth column.

17. The base station antenna of claim 16, wherein the first through fourth vertically-extending columns define a plurality of rows, and wherein all of the rows include a first radiating element that is located in the second column or the third column and a second radiating element that is located in the other of the second column or the third column.

18. The base station antenna of claim 17, wherein at least some of the first radiating elements are arranged as a plurality of vertically-stacked triangular arrangements of first radiating elements and at least some of the second radiating elements are arranged as a plurality of vertically-stacked triangular arrangements of second radiating elements.

19. The base station antenna of claim 18, wherein some of the first radiating elements in the triangular arrangements of first radiating elements are positioned in between some of the second radiating elements in the triangular arrangements of second radiating elements.

20. The base station antenna of claim 18, wherein one of the first radiating elements in a first of the triangular arrangements of first radiating elements is positioned in between two of the second radiating elements in a first of the triangular arrangements of second radiating elements, and one of the second radiating elements in the first of the triangular arrangements of second radiating elements is positioned in between two of the first radiating elements in the first of the triangular arrangements of first radiating elements.

21-23. (canceled)

24. The base station antenna of claim 18, wherein the first radiating elements that form the vertically-stacked triangular arrangements of first radiating elements are located exclusively in the first through third vertically-extending columns, and the second radiating elements that form the vertically-stacked triangular arrangements of second radiating elements are located exclusively in the second through fourth vertically-extending columns.

25-26. (canceled)

27. Abase station antenna, comprising:
a reflector;
a first radio frequency (“RF”) port;
a second RF port;
a first array that includes a plurality of first radiating elements that are coupled to the first RF port and mounted to extend forwardly from the reflector, wherein at least some of the first radiating elements are arranged as a plurality of vertically-stacked triangular arrangements of first radiating elements; and
a second array that includes a plurality of second radiating elements that are coupled to the second RF port and that are mounted to extend forwardly from the reflector, wherein at least some of the second radiating elements are arranged as a plurality of vertically-stacked triangular arrangements of second radiating elements,
wherein at least some of the triangular arrangements of first radiating elements are interleaved with some of the triangular arrangements of second radiating elements.

28. The base station antenna of claim 27, wherein each of the triangular arrangements of first radiating elements includes two horizontally-aligned first radiating elements and an additional first radiating element that is vertically offset from the two horizontally-aligned first radiating elements and in between a pair of vertically-extending axes that bisect the two horizontally-aligned first radiating elements.

29. (canceled)

30. The base station antenna of claim 27, wherein the first and second radiating elements are arranged in first through fourth vertically-extending columns that are positioned in numerical order.

31. The base station antenna of claim 30, wherein the first radiating elements that form the vertically stacked triangular arrangements of first radiating elements are located exclusively in the first through third vertically-extending columns, and the second radiating elements that form the vertically stacked triangular arrangements of second radiating elements are located exclusively in the second through fourth vertically-extending columns.

32-46. (canceled)
